(19) United States
(12) Patent Application Publication
(10) Pub. No.: US 2025/0382791 A1
(43) Pub. Date: Dec. 18, 2025

(54) CABLE GUIDE CASING

(71) Applicant: SOLETANCHE FREYSSINET, Rueil-Malmaison (FR)

(72) Inventor: Esteban ORTEGA, Alixan (FR)

(21) Appl. No.: 19/242,365

(22) Filed: Jun. 18, 2025

(30) Foreign Application Priority Data
Jun. 18, 2024 (EP) 24305958.1

(51) Int. Cl. E04B 1/94

(52) U.S. Cl. CPC E04B 1/947

(57) ABSTRACT

Firewall device for caulking an aperture defined in a separating element and traversed by through elements, notably consisting of cables, pipes or the like, this device being in the form of a casing of rectangular, circular or oval cross section, provided with a first aperture on a first face on which said through elements enter the casing, referred to as the front face of the casing, and a second aperture on a second face, referred to as the rear face of the casing, opposite the first face and forming an exit aperture for said through elements, such that the casing includes flaps constituting a frame for the first aperture of the casing, said device includes sheets of intumescent material covering a first part of the inner face of the casing on the rear face side of the casing, and blocks of caulking foam on the casing front face side covering a second part of the casing inner face, said foam blocks filling a first space between the casing wall(s) and said through elements, and said flaps forming retaining flanges for said foam blocks.

### PRIORITY CLAIM TO RELATED APPLICATIONS

This application is claims priority to EP patent application Ser. No. 24/305,958.1 filed on Jun. 18, 2024, which is incorporated herein by reference. To the extent appropriate, a claim of priority is made to the above disclosed application.

### TECHNICAL FIELD

The present disclosure relates to the field of gas-tight firewall bulkheads for electrical cables or pipes or pipeworks.

### PRIOR ART

It is known practice to produce firewall bulkhead devices. WO 2006/045985 A1 notably relates to a firewall device for caulking an aperture in a partition through which cables notably pass. This device is in the form of a tubular casing with a rectangular cross section equipped with an aperture through which cables are to pass. The tubular body is formed from two complementary tube portions which are assembled by assembly means and immobilized relative to the other. The device includes foam blocks or brushes on the partition side to close off the bulkhead and prevent particles contained in an air stream, or even such an air stream, from passing through the device, at least for a temperature below that of a fire. The device may also include intumescent means arranged on the inlet side of the tubular body.

For its part, US 2004/016191 A1 describes a frame intended to delimit access to a duct through a building floor, which comprises a rigid body part and a coating made of intumescent material on an inner surface of the rigid body part. The intumescent material has sufficient expansion capacity to close the aperture through the frame under conditions which produce expansion of the coating. Another firewall sleeve technology is described in WO 2017/059176 A1, which proposes a self-adjusting firewall sleeve for insertion into walls. The sleeve includes an access channel running through it to receive cables penetrating the wall. Opposite firewall buffers on either side of the cables, mounted in a circular arc, are applied to the cables. Projecting blocks attached to the buffers provide self-adjusting capability and leaktightness to the device, so as to prevent air or smoke leaks around the cables.

### Technical Problem

These known solutions do not make it possible to simply add or remove cables or pipework elements without reducing or disrupting the leaktightness of the passageway. Similarly, some of these solutions are unsatisfactory, as they do not allow both fire stopping and restricted air permeability. For others, their recessed positioning and restricted dimensions mean that, in order to restore the firewall rating of the bulkhead, numerous modules have to be juxtaposed, secondary sealants have to be used and, above all, cable trays have to be interrupted through the separating element, making the firewall caulking operations long and laborious.

### DESCRIPTION OF THE INVENTION

In view of this situation, the present disclosure proposes a firewall device for caulking an aperture defined in a separating element and traversed by through elements, notably consisting of cables, cable trays, pipework elements or the like, this device being in the form of a casing of rectangular, circular or oval cross section, equipped with a first aperture on a first face, called the front face of the casing, for entry of said through elements into the casing, and a second aperture on a second face, called the rear face of the casing, opposite the first face and forming an exit aperture for said through elements, characterized in that the casing includes flaps constituting a frame for the first aperture of the casing, in that said device includes sheets of intumescent material, covering a first part of the inner face of the casing on the rear face side of the casing and fixed to the casing, and blocks of caulking foam on the front face side of the casing covering a second part of the inner face of the casing, said foam blocks filling a first space between the wall(s) of the casing and said through elements, and in that said flaps form retaining flanges for said foam blocks.

Under non-accidental conditions, the invention thus allows the bulkhead to remain open while at the same time maintaining passive fire separation and restricting air permeability as much as possible, both when there is no fire and during a fire.

The casing may be circular in cross section, with the flaps coming from a front edge of the casing and facing the inner side of the casing.

The casing can also be parallelepiped-shaped in cross-section, said flaps comprising first flaps coming from a ceiling and side faces of the casing on the first aperture side of the casing and including at least one second flap folded back from the bottom of the casing, said first and second flaps forming a frame of the first aperture facing the inner side of the casing, said first flaps and said at least one second flap forming said retaining flanges of said foam blocks.

The casing may be formed in two parts and include a first part, forming said casing ceiling and said casing side faces, and a second part, forming a casing bottom, the first part including said first flaps, the bottom including said second flap and also including third flaps folded back for application to said side faces.

The second part of the casing is advantageously removable from the first part of the casing, with the casing in position on said separating element.

The device may include toggle and hook-type locking devices between the first part of the casing and the second part of the casing.

The casing may include casing fixing tabs on the rear face of the casing.

Said tabs may advantageously frame the casing and be pierced with holes for the passage of screws securing the casing to the separating element.

Said foam blocks may extend from said front face to 20-50% of the depth of the casing from its front face, with said sheets of intumescent material extending the full depth to the rear face of the casing.

The material of said sheets of intumescent material may be made from:
a. at least one PVC resin suitable for extrusion processes or via a plastisol-type route;
b. at least one plasticizer;
c. at least one flame retardant and/or charring agent.

The intumescent material may advantageously contain secondary fillers chosen from kaolin, colloidal silica, dyes and pigments.

The flame retardant and/or charring agent is advantageously chosen from expandable graphites, ammonium polyphosphates, zinc borate and hydrated alumina.

The intumescent material is advantageously a material gelled at a temperature of 140° C. to 200° C. including 20% to 60% by weight of PVC resin, 10% to 70% by weight of phosphate plasticizer, 10% to 50% by weight of exfoliating graphite.

The caulking foam is preferably a closed-cell elastic foam.

The caulking foam is preferably chosen from polyurethane foam, synthetic rubber foam of the chloroprene, NBR or EPDM type, or silicone foam including flame-retardant fillers.

### BRIEF DESCRIPTION OF THE DRAWINGS

Other features, details and advantages of the invention will emerge on reading the following detailed description of non-limiting implementation examples, and on analysis of the appended drawings, in which:

FIG. 1 shows a perspective view of a firewall device of the present disclosure;

FIG. 2 shows a three-quarter perspective front view of the firewall device;

FIG. 3 shows a three-quarter perspective rear view of the firewall device;

FIG. 4 shows a three-quarter perspective exploded front view of the firewall device;

FIG. 5 shows a three-quarter perspective exploded rear view of the firewall device.

### DESCRIPTION OF EMBODIMENTS

The drawings and the description hereinbelow contain elements which may not only serve to better understand the present invention, but also contribute to its definition, where appropriate.

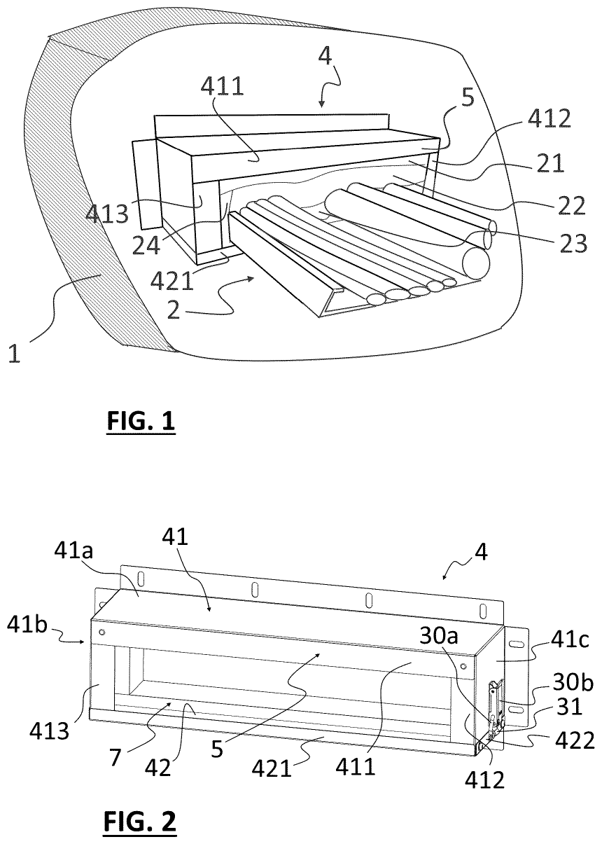

Reference is now made to FIG. 1, which represents a device used for providing a firewall caulking for a bulkhead allowing the passage of cables or pipework elements 2 through a partition 1 such as a wall or ceiling provided with a through aperture 1a. The invention is in the form of a casing 4, notably a steel metal casing.

According to FIG. 2, the parallelepiped-shaped casing is equipped with a first aperture 7 on a first entry face 5 of said through elements 2 into the casing, called the front face of the casing.

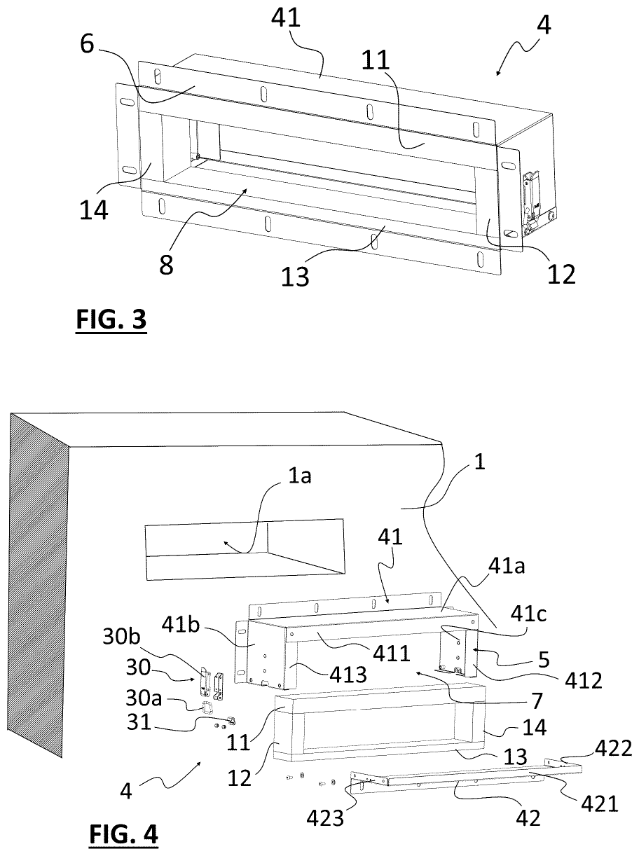

According to FIG. 3, the casing is equipped with a second aperture 8, on a second face 6 of the casing, on the separating element side, opposite the first face. The second face 6, called the “rear” face of the casing, forms an aperture for the exit of said through elements 2.

According to FIG. 3, the casing is made in two parts and includes a first part 41, forming a ceiling 41a of the casing and two side faces 41b, 41c of the casing, and a second part 42, forming a bottom of the casing.

The first part of the casing includes first flaps 411, 412, 413 on the front face side, extending from the ceiling 41a and side faces 41b, 41c, constituting a frame for the first aperture 7 of the casing.

The second part 42 includes a second flap 421 folded from the casing base toward the said first part and extending the said frame.

The second part also includes third flaps 422, 423 folded from the casing base toward the said first part.

These third flaps are applied to the side faces 41b, 41c of the first part 41 to close the casing.

The second part of the casing 42 is removable from the first part 41 of the casing, with the casing in position on said separating element.

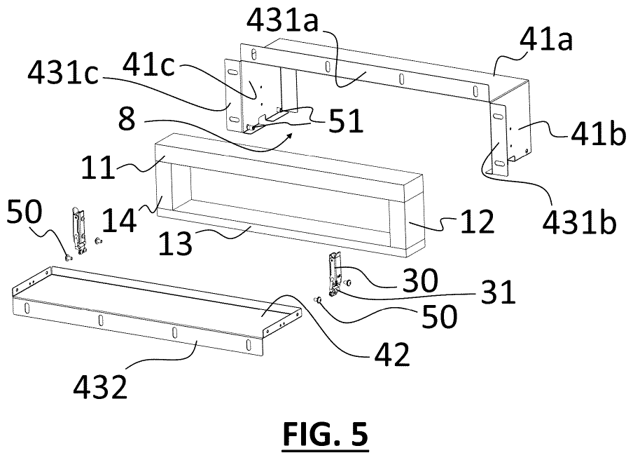

Shown in FIG. 5, screws 50 passing through the third flaps and screwing into inserts 51 attached to the side faces 41b, 41c serve to hold the two parts of the casing together.

Similarly, hook fasteners 30, 31 shown notably in FIG. 4, including a loop operated by a lever 30 to bind onto a hook 31, allow the two parts to be assembled while waiting for the screws 50 to be fitted and tightened.

Relative to FIGS. 3 and 5 notably, the device includes sheets of intumescent material 11, 12, 13, 14 covering a part of the inner face of the casing on the rear face of the casing.

These sheets, applied against the inner face of the casing, leave the passage 8 open for cables, cable trays or other bulkheads 2 passing through the casing and aperture 1a.

Returning to FIG. 1, on the front side of the casing, the device includes caulking foam blocks 21, 22, 23, 24 on the front face side of the casing, filling a first space between the ceiling of the casing and said through elements and filling a second space between the bottom of the casing and said through elements.

Unlike the intumescent material sheets, the foam blocks fill and seal the aperture 8 to the greatest possible extent. Also, the first flaps 411, 412, 413 and second flap 421 form retaining walls of said foam blocks to prevent them from protruding towards the front of the casing.

The device of the present disclosure is applied around the bulkhead to be protected and can be installed independently of the presence or absence of existing bulkheads. The first part 41 of the casing and the second part 42 of the casing include fixing tabs 431a, 431b, 431c, 432 of the casing on the rear face of the casing.

These tabs, folded outwards from the top, side and bottom faces of the casing, frame the casing and are provided with through-holes for screws securing the casing to the partition 1.

The volume of the intumescent material increases considerably in the event of fire, allowing it to close the bulkhead and thus ensure firewall caulking in the event of fire, while the foam ensures relative sealing at normal room temperature.

As stated above, under non-accidental conditions, the invention thus allows the bulkhead to remain open, while at the same time maintaining passive fire separation and restricting air permeability as much as possible, both when there is no fire and during a fire. Doing so makes maintenance operations and the addition or removal of through elements very easy, with no additional need for any specific product or tool, since the foam on the front of the casing can be easily removed and replaced. Thus, the device of the present disclosure is compatible with premises having active automatic gas fire extinguishing systems or premises having to ensure a certain air-tightness between separating elements. In this case, this function is performed by polymer foam blocks. By virtue of its flexible, elastic nature, this foam hugs cables or through elements as closely as possible. The air permeability of the bulkhead is thus reduced, making the fire protection system compatible with automatic gas facilities.

It should be noted that in cases where there is a risk of fire on both sides of wall 1, two devices can be used, whereas when there is a risk of fire on only one side, the casing will be positioned on the side where the fire is likely to occur, so that the foam blocks provide a seal until the temperature is sufficient to trigger the intumescence of the intumescent material sheets, which will then close the aperture on the fire side.

Description of the intumescent material:

The intumescent material used here, but which can also be used independently of the casing described, is advantageously a PVC (polyvinyl chloride) resin-based material. It is known practice to obtain such materials by mixing such resins with intumescent and/or flame-retardant fillers via extrusion techniques. Advantageously, it is also possible to produce such compositions via a plastisol-type route. The material is thus produced via moulding techniques, in contrast to the usual practice of extruding PVC, which requires the use of expensive machinery.

PVC resins for plastisol are prepared by emulsion polymerization, affording particle sizes of between 1 and 20 μm (compared with 70 and 200 μm using conventional techniques). The addition of a plasticizer to this type of resin leads to a pasty mixture commonly referred to as plastisol. Immediately after manufacture, the plastisol is made up of a continuous phase of plasticizer and a discontinuous phase of PVC particles. Heating to temperatures above 100° C., and ideally between 14° and 200° C., allows gelation to take place, affording a homogeneous solid material. Needless to say, the gelation depends on both the temperature and the heating time.

Examples of formulations affording a PVC plastisol incorporating flame retardants.

The desired aim remains to be able to incorporate a significant proportion of flame-retardant agents into the plastisol mixture, so as to give the material obtained after gelling flame-retardant and fire-resistant properties. In this way, the material can be readily accessed without the use of expensive extruder-type machinery. In absolute terms, this technique also affords various shapes by moulding, not limited to rods or strips, as in the case of extrusion techniques.

Such a formulation is made up of:
a. at least one PVC resin derived from an emulsion polymerization process and applied to plastisol preparation. A distinction is made between PVC homopolymer resins and PVC/polyvinyl acetate (PVAc) copolymer resins. PVC/PVAc copolymers are mainly used in plastisols so as to reduce the gelling temperature;
b. at least one plasticizer. Advantageously, the invention is not limited to the use of conventional plasticizers such as phthalates (BBP, DOP, etc.), epoxidized plasticizers (epoxidized soybean oil, etc.) or chlorinated paraffins, preferring to use the well-known liquid phosphate as both plasticizer and flame retardant;
c. at least one flame retardant and/or charring agent such as expandable graphites, ammonium polyphosphates, zinc borate, hydrated alumina, etc.;
d. secondary feedstocks as required: kaolin, colloidal silica, dyes, pigments, etc.;
e. at least one rheological agent as required: solvent or viscosity reducer, UV stabilizer, etc.

After mixing the various constituents, the pasty mixture obtained is transferred by gravity into a mould and then placed in an oven at 150° C. for a few minutes. The time required for exposure to high temperature depends greatly on the thickness of the mixture to be gelled.

Such materials thus made may have intumescence contents at least 10 times greater than the initial thickness when subjected to fire temperatures.

The intumescent material is made in the form of intumescent strips which are glued or mechanically attached, by means of cleats, retaining plates attached by screwing into the casing or other.

Gas-tight blocks made from polymer foam are deformable, highly elastic blocks, suitable for fitting as closely as possible to the through elements. The foam may notably be polyurethane foam or other polymers, and ideally be closed-cell to resist the passage of gas through the fitted casing. The elasticity of the foam is such that it conforms to the through elements and returns to its original position if one or more of said elements are removed. Preferably, these foams are formulated using known flame-retardant fillers, so as to improve their reaction to fire and ensure that they do not ignite during the first few minutes of a fire, by which time the intumescent material has deployed and closed off the bulkhead.

FIG. 6 represents an example of a single-piece, parallelepiped-shaped tubular casing according to the invention, allowing the flaps retaining the foam blocks to be seen. FIG. 7 represents an example of a tubular casing with a circular cross section, in which the flaps are arranged around the perimeter of the casing inlet and face the inner side of the casing to retain the foam blocks.

### INDUSTRIAL APPLICATIONS

The present disclosure thus relates to a passive firewall caulking system for the passage of electrical cables, suitable for premises which must also meet gas-tightness requirements. It is directed towards meeting the following technical issues:
a. under non-accidental conditions, the system leaves the bulkhead free, thus allowing cable removal and electrical maintenance operations to be performed as easily as possible, without the need for special tools or additional products;
b. although leaving the bulkhead open, the system restricts its air permeability without compromising the functions disclosed in point a;
c. in the first minutes of a fire, the flexible polymer sealing strips make the bulkhead leaktight enough to allow the active gas extinguishing system to deploy in sufficient concentration so as to extinguish the fire or limit its spread.
d. should this first countermeasure fail, and the fire become fully developed, the intumescent PVC strips will take over at temperatures in excess of 150° C., with a consequent increase in their volume, which will have the effect of totally closing the bulkhead. The fire will then be confined to the room in which it broke out, and will not be able to spread to adjacent rooms or floors. This will allow the safe evacuation of people and the arrival of emergency services.

The device of the present disclosure is thus aimed at premises which must ensure a level of air-tightness and/or premises with active gas fire protection systems such as data centres, museums, or others.

Finally, the device of the present disclosure can be installed in new or renovated buildings independently of the presence or absence of bulkheads, and without interrupting cable trays or pipework elements.

The invention is not limited to the examples described above, purely as examples, but encompasses all the variants that may be envisaged by a person skilled in the art in the context of the protection sought.

1. Firewall device for caulking an aperture defined in a separating element and traversed by through elements, notably consisting of cables, cable trays, pipework elements or the like, this device being in the form of a casing of rectangular, circular or oval cross section, provided with a first aperture on a first face, on which said through elements enter the casing, referred to as the front face of the casing, and with a second aperture on a second face, referred to as the rear face of the casing, opposite the first face and forming an exit aperture for said through elements, wherein the casing includes flaps constituting a frame for the first aperture of the casing, in that said device includes sheets of intumescent material, covering a first part of the inner face of the casing on the rear face side of the casing and attached to the casing, and caulking foam blocks on the casing front face side covering a second part of the casing inner face, said foam blocks filling a first space between the casing wall(s) and said through elements, and in that said flaps form retaining flanges for said foam blocks.

2. Firewall device according to claim 1, for which the casing is circular in cross section, the flaps extending from a front edge of the casing and facing the inner side of the casing.

3. Firewall device according to claim 1, for which the casing is parallelepiped-shaped in cross section, said flaps including first flaps extending from a ceiling and side faces of the casing on the first aperture side of the casing and including at least one second flap folded back from the bottom of the casing, said first and second flaps forming a frame of the first aperture facing the inner side of the casing, said first flaps and said at least one second flap forming said retaining flanges of said foam blocks.

4. Firewall device according to claim 3, for which the casing is formed in two parts and includes a first part, forming said ceiling of the casing and said side faces of the casing, and a second part, forming a bottom of the casing, the first part including said first flaps, the bottom including said second flap and also including third flaps folded back to apply to said side faces.

5. Device according to claim 4, for which the second part of the casing is removable from the first part of the casing, with the casing in position on said separating element.

6. Device according to claim 4, including toggle and hook type locking devices between the first part of the casing and the second part of the casing.

7. Device according to claim 1, for which the casing includes casing fixing tabs on the rear face side of the casing.

8. Device according to claim 7, for which said tabs frame the casing and are pierced with holes for the passage of screws for securing the casing to the separating element.

9. Device according to claim 1, for which said foam blocks extend from said front face to 20-50% of the depth of the casing from its front face, said intumescent material sheets extending over the remaining depth to the rear face of the casing.

10. Device according to claim 1, for which the material of said sheets of intumescent material is made of:
a. at least one PVC resin suitable for extrusion processes or via a plastisol-type route;
b. at least one plasticizer;
c. at least one flame retardant and/or charring agent.

11. Device according to claim 10, for which the intumescent material contains secondary fillers chosen from kaolin, colloidal silica, dyes and pigments.

12. Device according to claim 10, for which the flame-retardant and/or charring agent is chosen from expandable graphites, ammonium polyphosphates, zinc borate and hydrated alumina.

13. Device according to claim 10, for which said intumescent material is a material gelled at a temperature of 140° C. to 200° C. including 20% to 60% by weight of PVC resin, 10% to 70% by weight of phosphate plasticizer, 10% to 50% by weight of exfoliating graphite.

14. Device according to claim 1, for which said caulking foam is a closed-cell elastic foam.

15. Device according to claim 14, for which said caulking foam is chosen from a polyurethane foam, a synthetic rubber foam of the chloroprene, NBR or EPDM type, or a silicone foam including flame-retardant fillers.
